(19) United States
(12) Patent Application Publication
(10) Pub. No.: US 2006/0177176 A1
(43) Pub. Date: Aug. 10, 2006

(54) Method and system for communication on optical fiber using mechanical modulation

(76) Inventors: Richard Wolff, Bozeman, MT (US); Yanchang Dong, Bozeman, MT (US)

Correspondence Address: COOLEY GODWARD LLP, THE BROWN BUILDING - 875 15TH STREET, NW, SUITE 800, WASHINGTON, DC, 20005-2221, US

(21) Appl. No.: 11/335,581

(22) Filed: Jan. 20, 2006

Related U.S. Application Data
(60) Provisional application No. 60/644,990, filed on Jan. 21, 2005.

(51) Int. Cl. G02B 6/28

(52) U.S. Cl. 385/24

(57) ABSTRACT

An optical communication system includes a first network component and a second network component, an optical fiber link carrying a primary optical communication channel between the first network component and the second network component, and an electrically actuated force generator positioned on the optical fiber link for non-invasively providing an other communication channel in addition to the primary communication channel.

### CROSS REFERENCE TO RELATED APPLICATION

This application claims the benefit of priority of U.S. Provisional Patent Application No. 60/644,990, filed Jan. 21, 2005, the complete and entire disclosure of which is specifically incorporated by reference into the present application.

### STATEMENT OF RIGHTS TO INVENTIONS MADE UNDER FEDERALLY SPONSORED RESEARCH

This invention was partially made with government support under United States National Science Foundation Montana EPSCOR Interdisciplinary Graduate Program and the U.S. Government may therefore have certain rights in the invention.

### FIELD OF THE INVENTION

The present invention relates to transmitting signals on optical fiber, and more particularly, to a method and system for communication on optical fiber using mechanical modulation.

### BACKGROUND OF THE INVENTION

Demand for broadband Internet services has prompted renewed interest in deploying optical networks having direct fiber connections to end users. In conventional networks, the optical signal is converted to the electrical domain at intermediate nodes as the optical signal travels from a head end of the optical path to each of the subscriber ends of the optical path. Thus, there are numerous monitoring and control points accessible for network control and management (NC&M). However, conventional networks use a large number of optoelectronic (O/E) converters to convert optical signals to electrical signals as well as electrical signals to optical signals.

Passive optical networks (PONs) provide an attractive low-cost approach of fiber deployment directly to end users. A PON architecture minimizes the number of expensive active elements, such as optoelectronic (O/E) converters. However, use of PONs necessitates the development of new approaches to network control and management (NC&M) because a reduction in the number of active elements makes it difficult to insert or detect signals other than at the end points of the links.

Phase modulation or frequency shifting of optical signals plays an important role in communications, sensing and signal processing applications. All-fiber devices, examples of which include polarizers, multiplexers, modulators, fiber lasers and amplifiers, can be used in many optical communication applications. All-fiber components can be easily connected to optical fibers and do not have the problem of matching the field profiles of a circularly symmetric single mode fiber pigtail to that of a rectangular cross-sectional integrated optoelectronic component. Further, all-fiber components do not have the problems of insertion loss and reflection that occur from the connections attaching the fiber end to a integrated optoelectronic component. Such losses and reflections decrease the reliability and transmission efficiency of an optical communication system.

Among these all-fiber devices and components, the all-fiber phase modulator acts on the optical phase of the light that propagates down the optical fiber. One type of all-fiber modulator stretches the optical fiber to generate an optical phase shift or frequency shift. The optical fiber stretching modulator consists of a jacketed optical fiber wound on a hollow cylindrical piezoelectric transducer. The optical fiber is stretched when a voltage is applied across the wall of the cylindrical piezoelectric transducer and causes a dynamic mechanical stressing of the optical fiber. This rudimental phase modulator has been used in correction of phase drift in a Mach-Zehnder interferometer and numerical fiber-optic sensor system applications, including a fiber optic gyroscope. P. Oberson and B. Huttner demonstrated a method that generates an optical frequency shift of ˜100 MHz by stretching an optical fiber (10 m) at 180 Hz via the Doppler Effect. This technique can be used in an optical frequency domain reflectometer (OFDM). However, to get a maximum optical phase shift by stretching, a very long length of optical fiber is needed.

Another popular technique to generate a phase shift in the optical signal traveling in an optical fiber is to squeeze the optical fiber. A recently reported device structure consists of a silica fiber coated with a radially polarized piezoelectric jacket that is sandwiched between coaxial thin film metallic electrodes. Application of an electric field between the metal electrodes induces strains in the piezoelectric jacket due to the converse piezoelectric effect. The strains in the jacket are directly transmitted to the glass fiber. The strain induces changes in refractive index and length of the fiber resulting in a phase shift of the optical propagating in the fiber core. However, the piezoelectric coating fabrication process is complicated and impractical to implement in large-scale networks

### SUMMARY OF THE INVENTION

Accordingly, the present invention is directed to a method and system for communication on optical fiber using mechanical modulation that substantially obviates one or more of the problems due to limitations and disadvantages of the related art.

An object of the present invention is to provide a low-cost method of inserting NC&M signals on the optical data communication path without adding O/E converters or sacrificing communication bandwidth.

Another object of the present invention is to provide a low-cost system passively injecting unique signals at the subscriber end or at intermediate points of each optical path that can be uniquely and easily detected at the head end.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an optical communication system includes: a first network component and a second network component; an optical fiber link carrying a primary optical communication channel between the first network component and the second network component; an electrically actuated force generator positioned on the optical fiber link for providing an other communication channel in addition to the primary communication channel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is diagram illustrating how monitoring information can be provided to a network operator regarding data throughput to a network terminal.

FIG. 2 is a cross-sectional illustration of a squeezer and a circuit for applying a signal.

FIG. 3 is a diagram of an optical circuit for testing the output of a electrically actuated force generator.

FIG. 4 is the recovered transmitted waveform at the detector output.

FIG. 5 is the fast Fourier transform (FFT) of the received signal shown in FIG. 4.

FIG. 6 illustrates the conventional Frequency Shift Key (FSK) technique.

FIG. 7 illustrates a system architecture showing a FSK modulator and FSK demodulator for data communications.

FIG. 8 shows an output waveform of received data from the FSK demodulator.

### DETAILED DESCRIPTION OF THE PREFERRED EMBODIMENTS

Reference will now be made in detail to the preferred embodiments of the present invention, examples of which are illustrated in the accompanying drawings.

In embodiments of the present invention, electrically actuated force generators, such as piezoelectric actuators or micro-electromechanical devices, are used to squeeze or strain the optical fiber to produce an optical phase shift or an optical frequency shift. The use of electrically actuated force generator on a fiber is non-invasive to the optical fiber and can be added to existing optical fiber links between network components by positioning the electrically actuated force generator onto the jacketed fiber at a location adjacent to a terminating connector or at an intermediate point of the optical fiber link. Thus, additional information can be transmitted along a fiber optic link without interrupting or interferring with the normal communication signal in the optical fiber link. This additional information is provided on the optical fiber link by modulating the optical fiber link by squeezing or straining the optical fiber to slightly change its index of refraction. The additional information can be detected by measuring the resulting frequency or phase shift of the optical signal in the fiber optic link.

Such an additional information channel can be used for transferring monitoring and control information for network components connected to the optical fiber link. Thus, a network operator can monitor network equipment at intermediate points or the end user network terminal without having to combine monitoring information with data on the primary communications channel of the optical fiber link. This technique provides a simple and inexpensive method of transferring signaling and control data between network components on an operating optical fiber link between and amongst network components without interferring with the primary data on the optical fiber links of the network components.

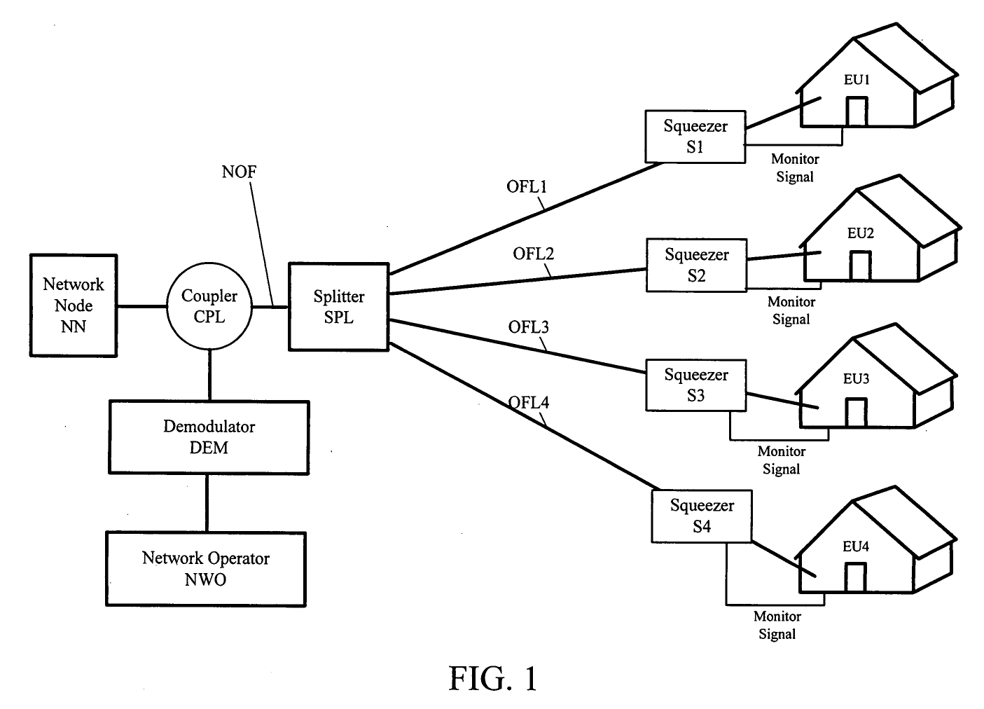

FIG. 1 is diagram illustrating how monitoring information can be provided to a network operator regarding data throughput of a network to a network terminal. As shown in FIG. 1, the network terminals of end users EU1-EU4 can be configured to providing monitoring signals to electrically actuated force generators, such as squeezers S1-S4, on the optical fiber links OFL1-OFL4 to the respective end user network terminals at a location on the optical fiber link adjacent to a terminating connector of the optical fiber link. Other network components, such as network switching equipment or network managing equipment, can also be configured to provide monitoring signals to a electrically actuated force generators on an optical fiber link, so that the network components can send signals via an optical fiber link without interferring with the primary data on the optical fiber link. The optical fiber links OFL1-OFL4 pass straight through the electrically actuated force generators, such as squeezers S1-S4, and are terminally connected between two network components.

The electrically actuated force generators, such as squeezers S1-S4, impart monitoring information onto the optical signals of the optical fiber links OFL1-OFL4 based upon monitoring signals from the the network terminals of end users EU1-EU4. The monitoring information is encoded so as to be unique to a specific network terminal or other type of network component. Likewise, control information should also be encoded so as to be unique to a specific network terminal or other type of network component. The optical fiber links OFL1 -OFL4 shown in FIG. 1 are attached to a splitter SPL such that several optical fiber links are interconnected to network optical fiber link NOF from a network node NN. Thus, each of the optical fiber links OFL1-OFL4A shown in FIG. 1 are terminally connected between a first network component, which is the splitter SPL, and a second network component, which is one of the network terminals of end users EU1-EU4. A coupler CPL is used to interconnect a demodulator DEM to the network optical fiber link NOF such that a network operator NWO can monitor network data to the network terminal of an end user.

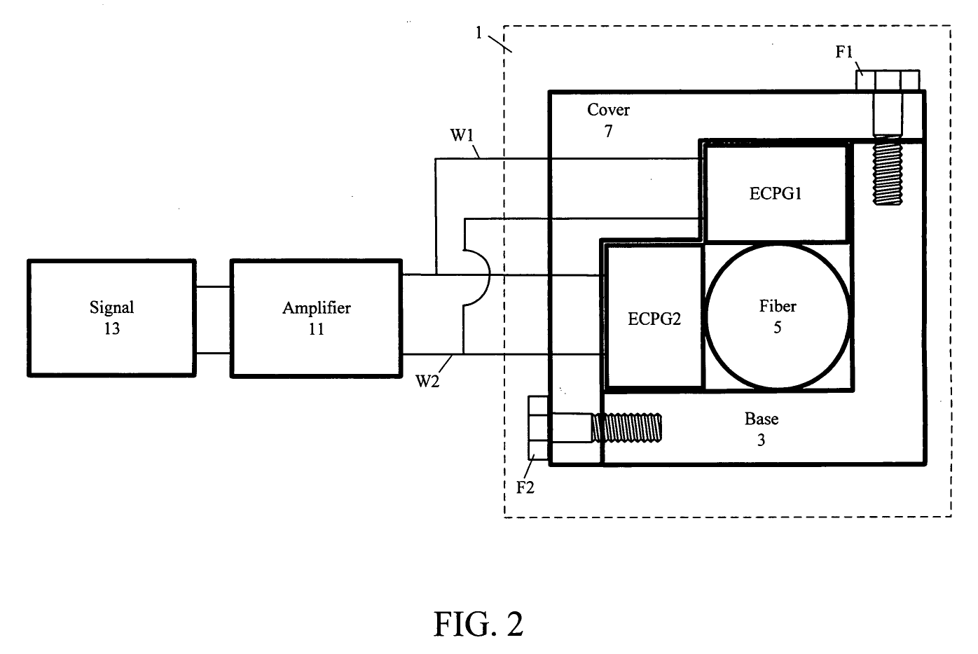

FIG. 2 is a cross-sectional illustration of a squeezer used as an electrically actuated force generator and a circuit for applying a signal to the squeezer. As shown in FIG. 2, squeezer 1 includes a base 3 on which a length of optical fiber 5 is positioned. Preferably, the base 3 has two surfaces that form a right angle with respect to each other and the optical fiber 5 is positioned in the base such the optical fiber is in contact with the two surfaces of the base 3. An electrically controlled pressure generator ECPG1 is positioned on a side of the optical fiber 5 that is opposite to a side of the optical fiber in contact with a surface of the base 3. In addition, another electrically controlled pressure generator ECPG2 can be positioned on a side of the optical fiber 5 that is opposite to a side of the optical fiber in contact with the other surface of the base 3. A cover 7 for retaining the electrically controlled pressure generators ECPG1 and ECPG2 in their positions with respect to the surfaces of the base is attached to the base 3 with fasteners F1 and F2. In another alternative, a collar surrounding the fiber can be used to produce a radial squeeze.

The first electrically controlled pressure generator ECPG1 in FIG. 2 can be actuated via an electrical signal to squeeze the optical fiber along a first axis between the first electrically controlled pressure generator ECPG1 and a surface of the base 3. Further, the second electrically controlled pressure generator ECPG2 in FIG. 2 can be actuated via an electrical signal to squeeze the optical fiber along a second axis between the a second electrically controlled pressure generator ECPG2 and a surface of the base 3. In the alternative, the first and second electrically controlled pressure generators ECPG1 and ECPG2 can be arranged within a base so that both squeeze an optical fiber along the same axis. In other words, the first and second electrically controlled pressure generators ECPG1 and ECPG2 can be on opposite sides of the optical fiber while the optical fiber contacts a surface of the base.

FIG. 2. also shows an amplifier 11 connected to both of the electrically controlled pressure generators ECPG1 and ECPG2. The amplifier 11 amplifies the strength of a signal 13 connected to the amplifier such that optical modulation corresponding to the signal 13 can be added to the optical signal on the optical fiber 5. Although FIG. 2. shows the use of two electrically controlled pressure generators concurrently to impart a single signal on the optical signal being carried by the fiber 5, each of the electrically controlled pressure generators could be used for different signals or only one electrically controlled pressure generator could be used to impart a signal on the optical signal being carried by the fiber 5.

Transmitting data using an electrically actuated force generator to modulate optical phase and frequency of an optical in an optical fiber is done by exploiting the strength and elasticity of optical fibers. The effect of squeezing or straining the fiber to transmit data can be detected by using an interferometer at the receiving point in the system. When the fiber is squeezed or strained, the refractive index of the fiber is changed thus modifying the optical path traversed by light propagating through the fiber and changing the light phase. This is equivalent to a displacement of the light source with respect to the end of the fiber. If the velocity of the effective displacement is high enough, it can generate a frequency shift of the light, caused by the Doppler effect.

Light phase is defined as Φ=βL=knL [4], where β is the wave propagation constant, k is the free space optical wavenumber, n is the index of refraction of the fiber and L is the fiber length. Optical path length is defined as Lₒₚₜ=nL. The variation of optical path is ΔLₒₚₜ=ΔnL+ΔLn. Because the squeezing of the fiber generally only changes the refractive index and does not change the fiber length, the variation of optical path is ΔLₒₚₜ=ΔnL. If the light is propagating in the Z direction, the effective index of refraction is n, in radial direction that delays the propagation of a transverse EM wave [10]). By the photo-elastic effect,

$$\begin{matrix}Δ ( \frac{1}{{n}_{r}^{2}} ) = {p}_{11} {ɛ}_{xx} + {p}_{12} {ɛ}_{yy} + {p}_{12} {ɛ}_{zz} , & \end{matrix} \qquad [ 4 ]$$

where p₁₁,p₁₂ are the strain optic coefficient, εₓₓ=ε_{yy}=εᵣ<0.01 are the strains in r(xx, yy) direction, ε_{zz}=0 is the strain in z direction. The variation of refractive index is

$$Δ n = Δ {n}_{r} = - \frac{1}{2} {n}^{3} ( {p}_{11} + {p}_{12} ) {ɛ}_{r}$$

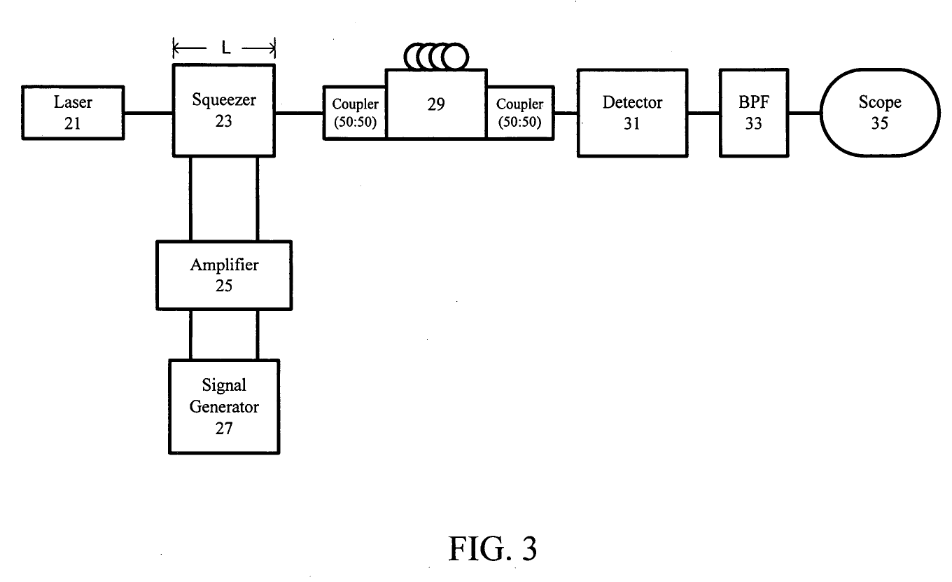

and the variation of optical path then is

$$Δ {L}_{opt} = Δ n L = - \frac{1}{2} {n}^{3} ( {p}_{11} + {p}_{12} ) {ɛ}_{r} L$$

where L is the fiber length that the squeezer covers, as shown in FIG. 3. Let εᵣ=0.01 sin(\overline{ω}ₘt), \overline{ω}ₘ is the squeezer angular frequency (modulating angular frequency).
Now

$$\begin{matrix}Δ {L}_{opt} = Δ n L \\ = - \frac{1}{2} {n}^{3} ( {p}_{11} + {p}_{12} ) {ɛ}_{r} L \\ = - \frac{1}{2 } {n}^{3} ( {p}_{11} + {p}_{12} ) L ( 0.01 sin ( {ϖ}_{m} t ) )\end{matrix}$$

and the optical phase shift becomes a time function as follows:

$$\begin{matrix}ΔΦ = \frac{2 π}{λ} Δ {L}_{opt} \\ = \frac{2 π}{λ} Δ n L \\ = - \frac{1}{2} \frac{2 π}{λ} {n}^{3} ( {p}_{11} + {p}_{12} ) {ɛ}_{r} L \\ = - \frac{1}{2} \frac{2 π}{λ } {n}^{3} ( {p}_{11} + {p}_{12} ) L ( 0.01 sin ( {ϖ}_{m} t ) )\end{matrix}$$

The displacement velocity is

$$v = \frac{d Δ {L}_{opt}}{dt} .$$

From Doppler theory, the frequency shift is given by the equation

$$Δ f = {f}_{0} \frac{v}{c} .$$

FIG. 3 is a diagram of an optical circuit for testing the output of a electrically actuated force generator. The optical circuit includes a laser 21, a piezoelectric actuator as a squeezer 23, a high voltage amplifier 25, optical couplers (50:50) 29, a photo-detector 31, a band-pass filter 33, an oscilloscope 35 and single mode fiber 37. The piezo-actuator is driven at the frequency of the signal generator by the high voltage amplifier to squeeze the optical fiber at the applied frequency, which can be shifted at a lower frequency to data modulation. At the receiving end of the system, two 50:50 couplers 29 with 1 meter of fiber in each arm and photo-detector 31 constitute an interferometer to detect the optical phase shift generated by squeezing the optical fiber 37. A band-pass filter 33 is used to filter out DC and high frequencies components of current from photo-detector 31 so as to decrease the noise and to see the results easily and clearly.

In the circuit of FIG. 3, a PL022 piezoelectric transducer from PI Corporation was selected because of its high resonant frequency, low electrical capacitance and suitable displacement in response to an electrical signal. Piezoelectric currents can be calculated by the following equations
Average current Iₐf*C*Vₚₚ, Peak current Iₘₐₓ=f*π*C*Vₚₚ
The maximum operating frequency can be as great as 10% of the resonant frequency, which for the PL022 is 30 kHz. Hence Iₘₐₓ=π*f*C*Vₚₚ=78.5*f*Vₚₚ*10⁻⁶ where current I is Amperes, Frequency f is kHz, Voltage V is Volts and Capacitance C of a piezoelectric actuator is farads. If the applied frequency=10 kHz, drive voltage 50V, Imax will be 39.3 mA.

The displacement of the PL022 without resisting force is 2.2 μm at 100 V. Since the optical fiber 37 presents an opposing force, the displacement of the optical fiber will be proportional to the applied voltage Vₚₚ and a function of the stiffness of the optical fiber relative to the piezoelectric material. Let k be the relative stiffness of the two materials.

$$Displacement = \frac{1}{1 + k} \frac{{V}_{pp}}{100} 2.2 ( μ m )$$

Let k=1,

$$\begin{matrix}fiber - strain = \frac{displacement}{fiber - diameter} 100 \% \\ = \frac{1}{2} \frac{{V}_{pp}}{100} \frac{2.2}{125} * 100 \% \\ = 0.0088 * {V}_{pp} \%\end{matrix}$$

The Thorlabs MDT694 amplifier was suitable for driving piezoelectric actuator. When the length L squeezed by the squeezer was 1 cm., the refractive index of typical fiber n=1.467, the wavelength of the light through the fiber λ=1.5 μm, and the strain-optic coefficients are p₁₁=0.113, p₁₁₂=0.252. The variation of the optical path is as follows:

$$\begin{matrix}Δ {L}_{opt} ( t ) = Δ n L \\ = - \frac{1}{2} {n}^{3} ( {p}_{11} + {p}_{12} ) {ɛ}_{r} L \\ = - \frac{1}{2} {n}^{3} ( {p}_{11} + {p}_{12} ) L ( {ɛ}_{r} sin ( {ϖ}_{m} t ) ) \\ = - 0.5762 * L * {ɛ}_{r} * sin ( {ϖ}_{m} t )\end{matrix}$$

$$And$$

$$\begin{matrix}fiber - strain : {ɛ}_{r} = 0.0088 * {V}_{pp} \% \\ = 8.8 * {10}^{- 5} * {V}_{pp}\end{matrix}$$

So the optical phase shift is as follows:

$$\begin{matrix}phase \text{-} shift : Δ Φ = k * Δ {L}_{opt} ( t ) \\ = - \frac{2 π}{λ} * ( 0.5762 * L * {ɛ}_{r} * sin ( {ϖ}_{m} t ) ) \\ = - \frac{2 π}{λ} * 0.5762 * {ɛ}_{r} * sin ( {ϖ}_{m} t ) * L \\ = - \frac{2 π}{1.5 * {10}^{- 6}} * 0.5762 * 8.8 * {10}^{- 5} * {V}_{pp} * sin ( {ϖ}_{m} t ) * L \\ = - 212.4 * {V}_{pp} * sin ( {ϖ}_{m} t ) * L \\ = - 0.2124 * {V}_{pp} * sin ( {ϖ}_{m} t ) ( if \text{:} L = 0.001 m = 1 mm )\end{matrix}$$

Thus, the frequency shift is as follows:

$$\begin{matrix}Δ f = {f}_{0} \frac{v}{c} \\ = \frac{{f}_{0}}{c} \frac{ⅆ Δ {L}_{opt}}{ⅆ t} \\ = - \frac{1}{λ} \frac{ⅆ ( 0.5762 * L * {ɛ}_{r} * sin ( {ϖ}_{m} t ) )}{ⅆ t} \\ = - \frac{1}{λ} 0.5762 * L * {ɛ}_{r} * sin ( {ϖ}_{m} t ) * {ϖ}_{m} \\ = - \frac{2 π}{λ} * 0.5762 * L * {ɛ}_{r} * sin ( {ϖ}_{m} t ) * {f}_{m} \\ = Φ * {f}_{m} \\ = - 0.2124 * {V}_{pp} * sin ( {ϖ}_{m} t ) * {f}_{m} ( if \text{:} L = 1 mm )\end{matrix}$$

An interferometer consisting of two 50:50 couplers with 1 meter of fiber was used to detect the optical phase shift after squeezing. The phase difference between two arms of the interferometer is given by:

$$\begin{matrix}Δ φ = k [ ( L 1 - L 2 ) + ( Δ {L}_{opt} ( t - τ 1 ) - Δ {L}_{opt} ( t - τ 2 ) ) ] \\ = k \{ ( L 1 - L 2 ) - 0.5762 * L * {ɛ}_{r} * [ sin ( {ϖ}_{m} ( t - τ 1 ) ) - sin ( {ϖ}_{m} ( t - τ 2 ) ) ] \} \\ = k ( L 1 - L 2 ) - k * 0.5762 * L * {ɛ}_{r} * 2 * \\ sin ( {ϖ}_{m} \frac{τ 2 - τ 1}{2} ) cos ( {ϖ}_{m} ( t - \frac{τ 1 + τ 2}{2} ) )\end{matrix}$$

Here, the wave number

$$k = \frac{2 π}{λ} ,$$

L1, L2 are the length of interferometer arms plus the length from squeezer to the interferometer, τ1, τ2 represent, respectively, the propagation times of the two beams along the two arms.

$$\frac{τ 1 + τ 2}{2}$$

can be ignored for it is the initial phase and constant. And

$$\frac{τ 2 - τ 1}{2} = \frac{dn}{2 c} , d = L 2 - L 1.$$

So the phase difference can be written:

$$Δ φ ( t ) = - k * 0.5762 * L * {ɛ}_{r} * 2 * sin ( {ϖ}_{m} \frac{dn}{2 c} ) cos ( {ϖ}_{m} t ) + Ψ$$

where Ψ is a constant induced by k(L1-L2).
And usually

$${ϖ}_{m} \frac{dn}{2 c} < 0.1 .$$

Thus,

$$Δ φ ( t ) = - k * 0.5762 * L * {ɛ}_{r} * 2 * \frac{{ϖ}_{ m} dn}{2 c} * cos ( {ϖ}_{m} t ) + Ψ \\ = - \frac{2 π}{λ} * 0.5762 * L * {ɛ}_{r} * 1.467 * \frac{{ϖ}_{m} d}{c} * cos ( {ϖ}_{m} t ) + Ψ$$

The interferometer power function at the photo-detector is

$$P ( t ) = \frac{{P}_{0}}{2} [ 1 + cos ( Δ φ ( t ) ) ] .$$

The AC power thus is

$$\begin{matrix}{P}_{ac} ( t ) = \frac{{P}_{0}}{2} cos ( Δφ ( t ) ) = \frac{{P}_{0}}{2} cos [ α * cos ( {ϖ}_{m} t ) + Ψ ] \\ = \frac{{P}_{0}}{2} \{ cos ( Ψ ) cos [ α * cos ( {ϖ}_{m} t ) ] - sin ( Ψ ) sin [ α * cos ( {ϖ}_{m} t ) ] \}\end{matrix}$$

Where

$$α = - \frac{2 π}{λ} * 0.5762 * L * {ɛ}_{r} * 1.467 * \frac{{ϖ}_{m} d}{c}$$

From Taylor series for cos(x) and sin(x) we can get

$$\begin{matrix}{P}_{ac} ( t ) = \frac{{P}_{0}}{2} \{ cos ( Ψ ) cos [ α * cos ( {ϖ}_{m} t ) ] - sin ( Ψ ) sin [ α * cos ( {ϖ}_{m} t ) ] \} \\ = \frac{{P}_{0}}{2} cos ( Ψ ) * [ 1 - \frac{{( α * cos ( {ϖ}_{m} t ) )}^{2}}{2 !} + ⋯ ] - \\ \frac{ {P}_{ 0}}{ 2} sin ( Ψ ) [ α * cos ( {ϖ}_{ m} t ) - \frac{{( α * cos ( {ϖ}_{m} t ) )}^{3}}{3 !} + ⋯ \\ = \frac{{P}_{0}}{2} cos ( Ψ ) - \frac{{P}_{0}}{2} sin ( Ψ ) * α * cos ( {ϖ}_{m} t ) - \frac{{P}_{0}}{2} cos ( Ψ ) * \\ \frac{{( α * cos ( {ϖ}_{m} t ) )}^{2}}{2 !} + \frac{{P}_{0}}{2} sin ( Ψ ) * \frac{{( α * cos ( {ϖ}_{m} t ) )}^{3}}{3 !}\end{matrix}$$

Neglect higher order component, we get

$${P}_{ac} ( t ) = \frac{{P}_{0}}{2} cos ( Ψ ) - \frac{{P}_{0}}{2} sin ( Ψ ) * α * cos ( {ϖ}_{m} t )$$

So signal detected by interferometer can expressed as

$$P ( t ) = \frac{{P}_{0}}{2} [ 1 + cos ( Δφ ( t ) ) ] = \frac{{P}_{0}}{2} + \frac{{P}_{0}}{2} cos ( Ψ ) - \frac{{P}_{0}}{2} sin ( Ψ ) * α * cos ( {ϖ}_{m} t )$$

From this equation, the signal detected by the photo-detector is a sine wave plus a big DC component. After bandpass filter we get

$$\begin{matrix}P ( t ) = - \frac{{P}_{0}}{2} sin ( Ψ ) * α * cos ( {ϖ}_{m} t ) \\ = \frac{2 π}{λ} * 0.5762 * L * {ɛ}_{r} * n * \frac{{ϖ}_{m} d}{c} * \frac{{P}_{0}}{2} * sin ( Ψ ) * cos ( {ϖ}_{m} t )\end{matrix}$$

If Vₚₚ=50V, fₘ=20 kHz, L=2 mm, d=5 m, then Iₘₐₓ=78.5 mA, the resulting maximum optical phase shift degrees ΔΦ=21.24, the maximum frequency shift Δf=424.8 kHz. After the bandpass filter, a sine wave on the oscilloscope corresponding to the sine signal applied to the piezo actuator.

In another experiment, the optical fiber was first squeezed at 4 kHz, and without the bandpass filter, we detected a small sine wave superimposed on a big DC wave and not very clear, just as expected. Using a bandpass filter and amplifier we detected a clear sine wave with same 4 kHz frequency applied to the piezo actuator. Increasing the modulation frequency, the amplitude of the sine wave increases which verifies the equation:

$$P ( t ) = \frac{2 π}{λ} * 0.5762 * L * {ɛ}_{r} * n * \frac{{ϖ}_{m} d}{c} * \frac{{P}_{0}}{2} * sin ( Ψ ) * cos ( {ϖ}_{m} t )$$

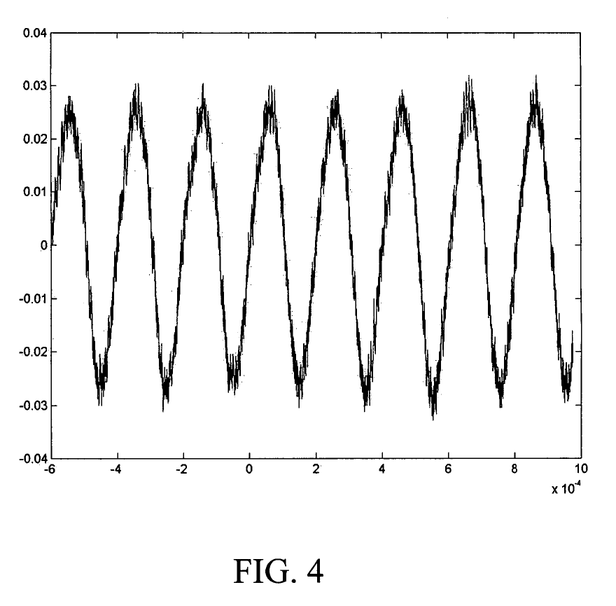

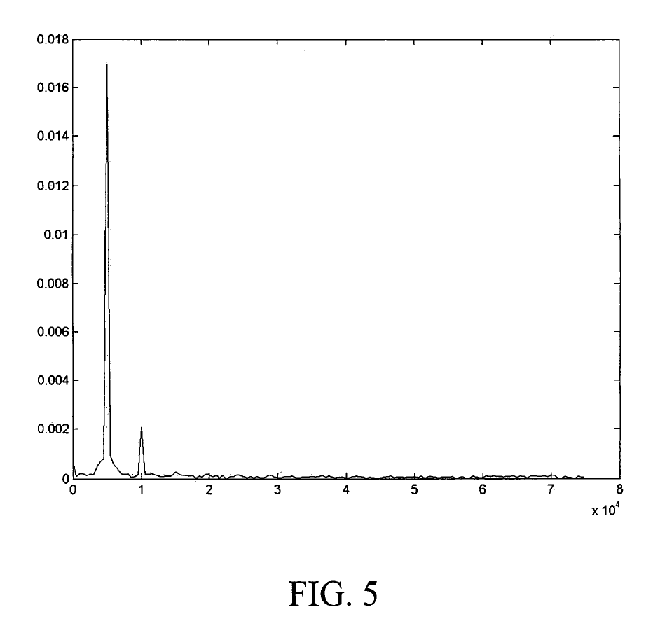

FIG. 4 shows experimental results after removal of the DC offset, and clearly indicates the recovery of the 5 kHz sine wave applied to the squeezer by the signal generator, validating the fidelity of the transmission system. FIG. 5 is the fast Fourier transform (FFT) of the received signal shown in FIG. 4. This power spectrum indicates that the received signal energy is predominately at the transmitted frequency with a small percentage of the energy appearing in the second harmonic.

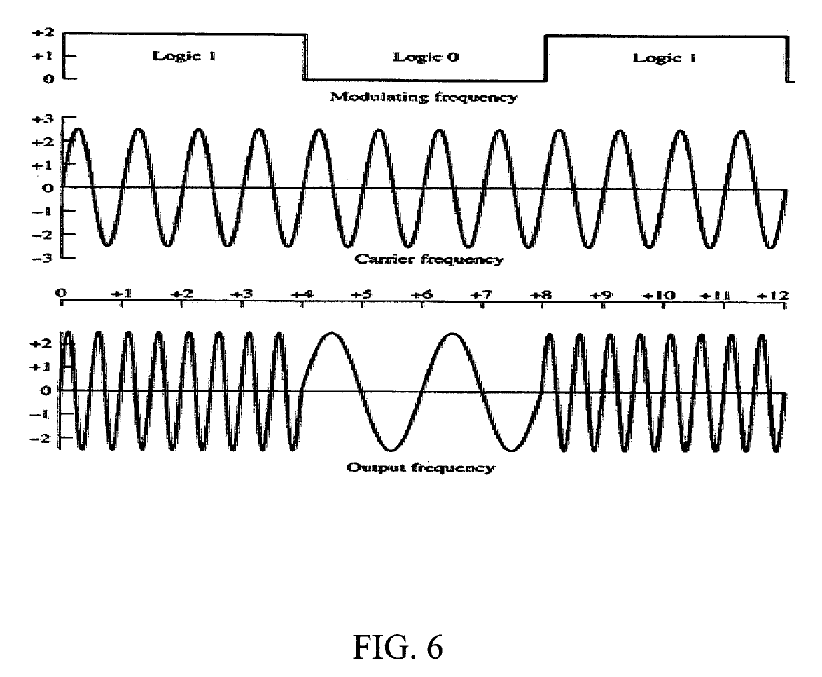

Experimental results have shown that squeezing the optical fiber at one end of the fiber at an audio frequency can generate an optical phase shift and this effect can be easily detected just by using an interferometer at the other end of the light path, which indicates that we can transmit information by squeezing the optical fiber by varying the applied frequency for squeezing the optical fiber. This method is very similar to the conventional Frequency Shift Key (FSK) technique shown in FIG. 6. Implementation of this technique is easier and cheaper because it does not require complicated hardware.

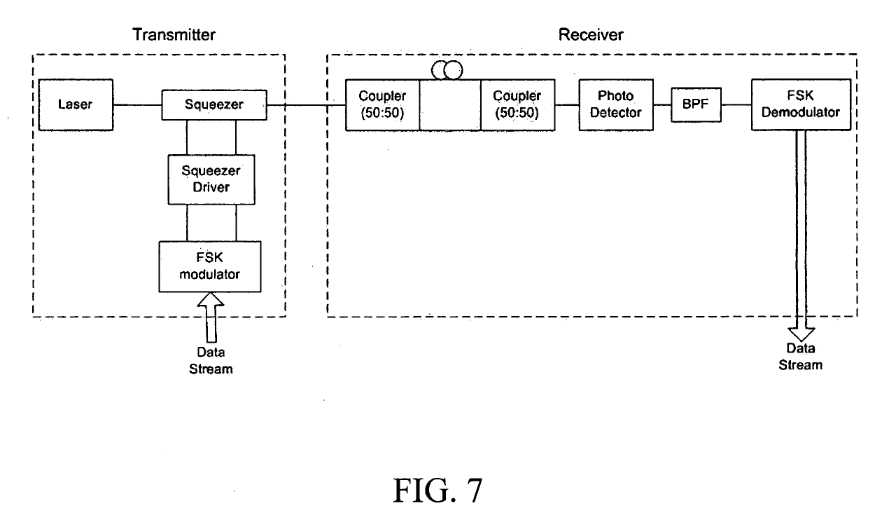

Transmission over an other channel in addition to the primary optical channel using FSK modulation has been verified. FIG. 7 illustrates a system architecture showing a FSK modulator and FSK demodulator for data communications. This system consists of transmitter and receiver and both transmitter and receiver include an electrical part and an optical part. A transmitter is made up of FSK modulator, squeezer driver and squeezer. First, a data stream comes into the FSK modulator where information data bits are encoded into a different frequency. The squeezer driver amplifies these different frequency sine wave signals for driving the squeezer. The squeezer modulates the optical phase by mechanically squeezing the optical fiber. In this way, the information is transmitted through optical fiber with original data transmission but does not interrupt original transmission, because the information is in optical phase not in light intensity. In other words, the original transmission detector can not see it from light intensity (On or Off).

The receiver includes an interferometer with two 50:50 couplers, photo detector, bandpass filter (BPF), and FSK demodulator. The interferometer detects the optical phase shift and translates the phase shift into an intensity shift. The photo detector detects this light intensity change and translates it into an electrical signal. This electrical signal includes a big DC component and several AC components. The bandpass filter removes the DC part and high order harmonics. After the FSK demodulator we recover the information data bits that have been transmitted through the fiber with original on-off keying transmission.

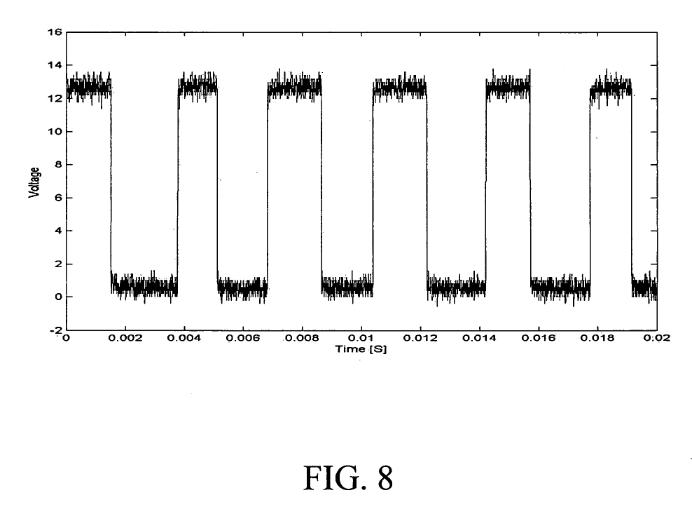

The system shown in FIG. 7 can transmit data at 500 bps using the FSK technique. The FSK transmitter was modulated at f0=8 kHz and f1=12 kHz with a stream of alternating zero and one bits (01010101010 . . . ) at a rate of 500 bps and a measured bit error rate of 0.000041, which validates this approach. Other system parameters in this experiment were signal voltage: 12.9 V, noise voltage: 3.0 V, signal power: 165.5, noise power: 8.8, and system SNR: 12.7 dB. Results measured at the output of the FSK demodulator are shown in FIG. 8.

As described above, a sine wave can be applied to electrically actuated force generator to induce a detectable phase shift on an optical signal in an optical fiber. Such a sine wave signal can be modulated with an applied electrical signal to impress digital information on the sine wave and transmit data along the optical fiber path. Thus, an additional information channel can be added non-invasively for transferring monitoring information associated with the communications link. Such a system enables a network operator to monitor and remotely control equipment without having to electrically combine such monitoring information with the data on the primary communications channel. This technique provides a simple and inexpensive method of transferring signalling and control data, or other types of data.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### REFERENCES

All publications and patent applications herein are incorporated by reference to the same extent as if each individual publication or patent application was specifically and individually indicated to be incorporated by reference.
[1] P. Oberson, B. Huttner, and N. Gisin, “frequency modulation via the Doppler effect in optical fiber”, optical letters, Apr. 1, 1999/vol. 24, No. 7
[2] N. H. Ky, H. G. Limberger, R. P. Salathe, and G. R. Fox, “400 MHz bandwidth all fiber phase modulators with ZnO coating on standard telecommunication fiber”, IEEE Photon. Technol. Lett. Vol. 8, pp. 629-631, May 1996
[3] M. IMAI, T. YANO, U. OHTSUKA, K. MOTOI and A. ODAJIMA, “Wide frequency fiber optic phase modulator using piezoelectric polymer coating”, IEEE photonics technology letters, Vol. 2, NO. 10, October 1990
[4] M. IMAI, T. SHIMIZU, Y. OHTSUKA and A. ODAJIMA, “an electric field sensitive fiber with coaxial electrodes for optical phase modulation”, Journal of lightwave technology, Vol. LT-5, No. 7, July 1987, IEEE

[5] Axel Bertholds and Pene Dndliker, “determination of the individual strainoptic coefficients in single mode optical fiber”, Lightwave technology, IEEE, Vol. 6, No. 1, 1988
[6] G. B. Hocker, “fiber optic sensing of pressure and temperature”, APPLIED OPTICS, Vl. 18, No. 9, 1979
[7] Paul R. Hoffman and Markk G. Kzyk, “position determination of an acoustic burst along a sagnac interferometer”, Lightwave technology, IEEE, Vol. 22, No. 2, 2004
[8] Ueda, H.; Okada, K.; Ford, B.; Mahony, G.; Hornung, S.; Faulkner, D.; Abiven, J.; Durel, S.; Ballart, R.; Erickson, J.; “Deployment status and common technical specifications for a B-PON system”, Communications Magazine, IEEE, Volume: 39, Issue: 12, December 2001 Pages: 134-141

[9] Maier, G.; Martinelli, M.; Pattavina, A.; Salvadori, E.; “Design and cost performance of the multistage WDM-PON access networks”, Lightwave Technology, Journal of, Volume: 18, Issue: 2, February 2000, Pages: 125-143.
[10] S. O. Kasap, “principle of electronic materials and devices”, Tata McGraw-Hill, 2002, Pages: 667.

What is claimed is:

1. An optical communication system, comprising:
a first network component and a second network component;
an optical fiber link carrying a primary optical communication channel between the first network component and the second network component;
an electrically actuated force generator positioned on the optical fiber link for providing an other communication channel in addition to the primary communication channel.

2. The optical communication system according to claim 1, wherein the other communication channel is carrying information from the first network component.

3. The optical communication system according to claim 1, wherein the optical fiber link is terminally connected between the first network component and the second network component.

4. The optical communication system according to claim 1, wherein the optical fiber link passes straight through and is unaffected by the electrically actuated force generator.

5. The optical communication system according to claim 1, wherein the electrically actuated force generator includes a base having a first surface contacting a length of the optical fiber link and a first electrically controlled pressure generator on a first side of the optical fiber link that is opposite to a second side of the optical fiber link in contact with the first surface of the base.

6. The optical communication system according to claim 5, wherein the base has a second surface contacting the length of the optical fiber link and a second electrically controlled pressure generator on a third side of the optical fiber link that is opposite to a fourth side of the optical fiber link in contact with the second surface of the base.

7. The optical communication system according to claim 1, wherein the electrically actuated force generator squeezes the optical fiber link to provide the other communication channel in addition to the primary communication channel.

8. The optical communication system according to claim 1, wherein the electrically actuated force generator strains the optical fiber link to provide an other communication channel in addition to the primary communication channel.

9. The optical communication system according to claim 1, wherein the other communication channel transmits data using the Frequency Shift Key technique.
